(19) United States
(12) Patent Application Publication
(10) Pub. No.: US 2024/0059935 A1
(43) Pub. Date: Feb. 22, 2024

(54) PHOTOCURABLE ADHESIVE FILM AND PREPARATION METHOD THEREOF

(71) Applicant: 3M INNOVATIVE PROPERTIES COMPANY, St. Paul, MN (US)

(72) Inventors: Seongwoo Kim, Suwon-si (KR); Do-Kwang Cho, Suwon-si (KR); Youhoon Kim, Woodbury, MN (US)

(21) Appl. No.: 18/269,250

(22) PCT Filed: Dec. 17, 2021
(86) PCT No.: PCT/IB2021/061973

§ 371 Date: Jun. 22, 2023

(30) Foreign Application Priority Data
Dec. 23, 2020 (KR) 10-2020-0182267

(51) Int. Cl. C09J 7/38; C09J 7/40; C09J 7/30; C09J 4/06; C09J 133/14

(52) U.S. Cl. CPC C09J 7/385; C09J 7/401; C09J 7/30; C09J 4/06; C09J 133/14; C09J 2203/318; C09J 2301/416; C09J 2301/312

(57) ABSTRACT

The present invention relates to a photocurable adhesive film and a preparation method thereof, and provides an adhesive film having excellent peeling adhesion and creep resistance at both room temperature and high temperature and a low modulus at a low temperature of −20° C. by using an acrylic monomer having a specific structure in a specific content range. Furthermore, since the adhesive film of the present invention may provide folding reliability and stability of a display device, the adhesive film can be usefully applied as an adhesive of a display device, particularly, a foldable display device field.

### BACKGROUND

The present invention relates to a photocurable adhesive film and a preparation method thereof.

Display-related technologies have been variously changed from smartphones to touch screens of vehicles and facilities for control. Recently, an interest in a foldable display capable of being freely bent without cracks or breakage of the display has been increased.

According to the emergence of such a foldable display, for example, there has been increased a demand for an adhesive, particularly an optically clear adhesive (OCA) that serves as an assembly layer or a gap filling layer between an outside, a cover lens or sheet and a lower display module of an electronic dislay assembly based on glass, polyethylene terephthalate (PET), polycarbonate (PC), polymethyl methacrylate (PMMA), polyimide (PI), polyethylene naphthalate (PEN), cyclic olefin copolymer, and the like.

For example, in addition to conventional performance such as optical transparency, adhesion, and durability according to the diversification of displays, an adhesive having the following adhesion function and physical properties is required.

First, the adhesive needs to have excellent peeling adhesion at a high temperature and second, excellent creep resistance at a high temperature, and third, a low modulus at a low temperature.

In order to satisfy these requirements, an adhesive composition using acrylic monomers such as acrylic acid has been studied, but in this case, the peeling adhesion may be improved, but there is a problem that the creep resistance is low or the modulus at the low temperature is increased, and as a result, there is a limit to apply the adhesive to various displays.

### PRIOR ART DOCUMENT

### Patent Document

(Patent Document 1) KR Registered Patent No. 0476798

### SUMMARY

Therefore, an object of the present invention is to provide an adhesive film, and a preparation method thereof capable of providing folding reliablity and stability of a dispaly device when applied to a foldable display, by excellent peeling adhesion and creep resistnace at both room temperature and high temperature and a low modulus at a low temperature.

In order to achieve the object, according to an aspect of the present invention, there is provided a photocurable adhesive film comprising an adhesive layer and at least one release layer, wherein the adhesive layer is induced from a photocurable adhesive composition comprising a prepolymer; an acrylic monomer having the following structural formula; an initiator; and a crosslinking agent, and the photocurable adhesive composition includes the acrylic monomer in an amount of 0.5 to 10 parts by weight based on 100 parts by weight of the prepolymer:

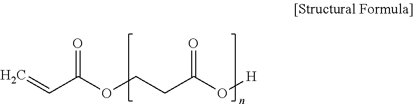

wherein, n is an integer of 1 to 3.

According to another aspect of the present invention, there is provided a preparation method of a photocurable adhesive film comprising preparing at least one release layer; and forming an adhesive layer by coating a photocurable adhesive composition on the at least one release layer, wherein the photocurable adhesive composition comprises a prepolymer; an acrylic monomer having the following structural formula; an initiator; and a crosslinking agent, and includes the acrylic monomer in an amount of 0.5 to 10 parts by weight based on 100 parts by weight of the prepolymer.

The photocurable adhesive film of the present invention can maintain excellent peeling adhesion at both room temperature and high temperature, excellent creep resistnace at a high temperature, and a low modulus at a low temperature of −20° C.

Furthermore, since the adhesive film of the present invention may provide folding reliability and stability of the display device, the adhesive film can be usefully applied as an adhesive of a display device, particularly, a foldable display field.

### BRIEF DESCRIPTION OF THE DRAWINGS

FIG. 1 is a schematic diagram of an adhesive film according to an embodiment of the present invention.

FIG. 2 illustrates schematically a preparation method of an adhesive film according to an embodiment of the present invention.

FIG. 3 illustrates schematically a preparation method of a photocurable adhesive composition according to an embodiment of the present invention.

### DETAILED DESCRIPTION

Advantages and features of the present invention, and methods for achieving the same will be apparent by referring to embodiments described in detail below with reference to the accompanying drawings. However, the present invention is not limited to embodiments disclosed below, but may be embodied in various different forms. That is, these embodiments will be provided to make the disclosure of the present invention be complete and completely notify the scope of the present invention to those skilled in the art to which the present invention pertains, and the present invention is just defined by the scope of the appended claims.

The shapes, sizes, ratios, angles, numbers, and the like illustrated in the drawings for describing the present invention are merely illustrative, and the present invention is not limited to details illustrated in the drawings. Further, in describing the present invention, a detailed explanation of known related technologies will be omitted when it is determined to unnecessarily obscure the subject matter of the present invention.

The terms such as “including,” “having,” and “comprising” used herein are generally intended to allow components other than the details described to be added unless the terms are used with “only”. When a component is expressed as a singular form, the component may include a plural form unless expressly stated otherwise.

Components should be interpreted to include an error range unless expressly stated otherwise.

When a position relation between two parts is described using the terms such as “on”, “under”, “above”, “below”, and “between”, one or more other parts may be positioned therebetween unless used with the expression “immediately” or “directly”.

Respective features of embodiments of the present invention can be partially or entirely connected or combined with each other, and can be technically interlocked or driven variously.

Hereinafter, embodiments of the present invention will be described in detail. The following embodiments to be described below will be provided as examples so that the spirit of the present invention can be fully transferred to those skilled in the art. Therefore, the present invention is not limited to embodiments to be described below and may also be embodied in different forms.

### Photocurable Adhesive Film

A photocurable adhesive film according to an exemplary embodiment of the present invention comprises an adhesive layer and at least one release layer, wherein the adhesive layer is induced from a photocurable adhesive composition comprising a prepolymer; an acrylic monomer having the following structural formula; an initiator; and a crosslinking agent, and the photocurable adhesive composition includes the acrylic monomer in an amount of 0.5 to 10 parts by weight based on 100 parts by weight of the prepolymer:

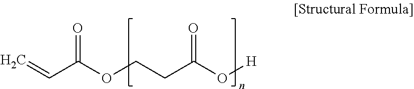

wherein, n is an integer of 1 to 3.

Since the adhesive layer is induced from the photocurable adhesive composition including the prepolymer, the acrylic monomer having the specific structure, the initiator, and the crosslinking agent, and particularly, the acrylic monomer having the specific structure has a specific content, the photocurable adhesive film according to an exemplary embodiment of the present invention may maintain excellent peeling adhesion at both room temperature and high temperature, excellent creep resistnace at a high temperature, and a low modulus at a low temperature of −20° C. Accordingly, since the photocurable adhesive film may provide folding relaliability and stability of the dispaly device when applied to the dislay, the photocurable adhesive film may be usefully used as a pressure sensitive adhesive (PSA) in a display device, for example, a foldable display.

In this application, the term “foldable display” may refer to a flexible display which is designed to be repetitively folded and unfolded like paper and has a folding portion with a curvature radius within 5 mm.

Hereinafter, each configuration layer of the photocurable adhesive film will be described in detail.

Adhesive layer

The photocurable adhesive film according to an exemplary embodiment of the present invention includes an ahesive layer.

For example, the adhesive layer may serve as an assemly layer or a gap filling layer between a cover lense or sheet and a lower display module of an electronic display assembly based on glass, PET, PC, PMMA, polyimide, PEN, cyclic olefin copolymer, and the like when applied to the display. In addition, the adhesive layer may increase luminance and contrast to improve the performance of the display, and may serve as a structural support to the assembly and serve to protect a component by absorbing stress added by folding to prevent damage or breakage to the component of a display panel.

In the photocurable adhesive film according to an exemplary embodiment of the present invention, the adhesive layer is induced from the photocurable adhesive composition including the prepolymer, the acrylic monomer having the structural formula, the initiator, and the crosslinking agent.

Specifically, the adhesive layer may be formed by coating and curing the photocurable adhesive composition on one surface of the at least one release layer. For example, the adhesive layer may be formed by photocuring the photocurable adhesive composition.

According to the exemplary embodiment of the present invention, the photocurable adhesive composition used for forming the adhesive layer includes the acrylic monomer having the specific structural formula to implement a desired effect of the present invention.

Generally, in the case of using a polar mononer having a carboxyl group, for example, a polar monomer such as acrylic acid (AA) in the adhesive layer, the peeling adhesion may be increased, but in order to satisfy the peeling adhesion required in a specific range or more, a used amount of the monomer needs to be increased. However, in the case of increasing the used amount of the monomer, the modulus at the low temperature may be largely increased. Particularly, in order to absorb the added stress of the adhesive layer, the modulus at the low temperatue of the adhesive layer needs to be lowered, and when the modulus is increased, it is not preferred in that deformation or defects such as cracks and delamination may be caused.

According to the exemplary embodiment of the present invention, the acrylic monomer is a polar monomer which includes a carboxyl group and a carbonyl group and includes an ethyl group between the carboxyl group and the carbonyl group. Such a structural feature may be advantageous to improve the creep resistance while increasing the peeling adhesion at both room temperature and high temperature.

In addition, although the used amount of the acrylic monomer is increased within the range according to the exemplary embodiment of the present invention, it is possible to maintain a low modulus at a low temperature and excellent creep resistance at a high temperature while implementing the improved peeling adhesion.

In the structural formula, when n is 0, the modulus may be increased to cause the deformation or defects such as cracks and delamination. In addition, when n is 4 or higher, there may be a problem that the creep resistance is deteriorated or the peeling adhesion is reduced.

Further, the acrylic monomer may have a glass transition temperature (Tg) of 10° C. to 50° C., for example, 20° C. to 45° C., or 25° C. to 43° C. When the acrylic monomer has the glass transition temperature (Tg) in the range, an adhesive layer having a low modulus at a low temperature of −20° C. may be provided.

The acrylic monomer may include, for example, β-carboxyethyl acrylate (β-CEA).

The β-CEA is a very flexible monomer compared with other functional monomers such as acrylic acid (AA) in which n is 0 in the structural formula (referred to as a β-CEA oligomer when n is 1 to 3) and a glass transition temperature is about 37° C. The β-CEA having these structural and physical features may particularly play a very important role to improve peeling adhesion and creep resistance at room temperature and high temperature and lower a modulus at a low temperature. Furthermore, when the adhesive layer is applied to a foldable display, the adhesive layer has excellent durability when repeating folding and unfolding hundreds of thousands times or more, for example, at room temperature, low temperature of −20° C., and high temperature of 60° C. or higher.

The acrylic monomer may be included in an amount of 0.5 to 10 parts by weight based on 100 parts by weight of the prepolymer. Specifically, the acrylic monomer may be included in an amount of 1 to 10 parts by weight, 1 to 8 parts by weight, 3 to 8 parts by weight, 3 to 6.5 parts by weight, 5 to 10 parts by weight, 5 to 8 parts by weight, or 5 to 7 parts by weight based on 100 parts by weight of the prepolymer.

When the acrylic monomer satisfies the range, it may be advantageous to satisfy desired effects in the exemplary embodiment of the present invention, that is, all of excellent peeling adhesion and creep resistance at room temperature and high temperature and a low modulus at a low temperature. If the acrylic monomer is not used or less than the range, the peeling adhesion and the creep resistance may be lowered, and when the acrylic monomer is more than the range, the modulus at the low temperature may be increased.

Meanwhile, according to the exemplary embodiment of the present invention, the photocurable adhesive composition includes a prepolymer.

The prepolymer may exhibit an adhesive property as a main component of the photocurable adhesive composition. In addition, the prepolymer may react (that is, be crosslinked) with a crosslinking agent to form a film and the like.

The prepolymer may contain functional groups which are reactive with the crosslinking agent. For example, the prepolymer may have at least one functional group selected from the group consisting of a carboxyl group, a hydroxyl group, an acryl group, a methacryl group, an acetate group, an amide group, an amine group and a glycidyl group.

As an example, the prepolymer may be an acrylic resin.

Specifically, the prepolymer may be an acrylic copolymer resin.

The prepolymer may be formed from a prepolymerization composition comprising a first monomer and a second monomer.

The first monomer may comprise an aliphatic or aromatic hydrocarbon-based acrylate monomer having 1 to 30 carbon atoms.

The first monomer may include at least one monomer selected from the group consisting of, for example, methyl acrylate, methyl (meth)acrylate, ethyl acrylate, ethyl (meth)acrylate, benzyl (meth)acrylate, n-butyl acrylate, n-butyl (meth)acrylate, sec-butyl acrylate, sec-butyl (meth)acrylate, ter-butyl acrylate, ter-butyl (meth)acrylate, cyclohexyl (meth)acrylate, iso-decyl (meth)acrylate, n-decyl (meth)acrylate, lauryl (meth)acrylate, 2-ethylhexyl acrylate, 2-ethylhexyl (meth)acrylate, n-nonyl acrylate, n-hexyl acrylate, iso-octyl acrylate, n-octyl acrylate, n-octyl (meth)acrylate, and isobonyl acrylate. The first monomer may include at least one monomer selected from the group consisting of, for example, benzyl (meth)acrylate, n-butyl acrylate, n-butyl (meth)acrylate, sec-butyl acrylate, 2-ethylhexyl acrylate, isobonyl acrylate, n-nonyl acrylate, n-hexyl acrylate, n-octyl acrylate, and n-octyl (meth)acrylate.

The second monomer may include a functional monomer including at least one hetero atom. At this time, the hetero may include at least one hetero atom selected from the group consisting of N, O, S and P in addition to C and H.

The second monomer may include at least one monomer selected from the group consisting of acrylic acid, vinyl acetate, 2,3-epoxypropyl (meth)acrylate, dimethyl acrylamide, acryloyl morpholine, 2-hydroxyethyl acrylate, and 2-hydroxyethyl (meth)acrylate. The second monomer may include at least one monomer selected from the group consisting of acrylic acid, vinyl acetate, and 2-hydroxyethyl acrylate.

For example, a combination of the first monomer and the second monomer may include 2-ethylhexyl acrylate and acrylic acid; 2-ethylhexyl acrylate and 2-hydroxyethyl acrylate; n-butyl acrylate and acrylic acid; or n-butyl acrylate and 2-hydroxyethyl acrylate.

The first monomer may be included in an amount of 90 parts by weight to 99 parts by weight, preferably 94 parts by weight to 98 parts by weight based on the total sum of the first monomer and the second monomer (the total sum of the monomer mixtures). When the content of the first monomer is more than the range, there may be a problem that the peeling adhesion and the creep resistance are lowered, and when the content of the first monomer is less than the range, the modulus at the low temperature may be increased.

The second monomer may be included in an amount of 1 parts by weight to 10 parts by weight, preferably 2 parts by weight to 6 parts by weight based on the total sum of the first monomer and the second monomer. When the content of the second monomer is more than the range, the modulus at the low temperature may be increased. When the content of the second monomer is less than the range, there may be a problem that the peeling adhesion and the creep resistance are lowered.

A weight ratio of the first monomer and the second monomer may be 1:0.01 to 0.1. Specifically, the weight ratio of the first monomer and the second monomer may be 1:0.01 to 0.09, 1:0.01 to 0.08, 1:0.02 to 0.06, or 1:0.02 to 0.05. When the first monomer and the second monomer satisfy the weight ratio in the specific range, it is possible to implement excellent creep resistance at a high temperature and a low modulus at a low temperature.

The prepolymerization composition may comprise a first initiator in addition to the first monomer and the second monomer.

The content of the first initiator may be 0.001 to 1 parts by weight based on 100 parts by weight of the prepolymerization composition. Specifically, the content of the first initiator may be 0.01 parts by weight to 1 parts by weight or 0.1 parts by weight to 0.5 parts by weight based on 100 parts by weight of the prepolymerization composition.

As the first initiator, a general photoinitiator may be used, and for example, as the photoinitiator, at least one selected from the group consisting of ketones (benzophenone, acetophenone, etc.), benzoins, benzoin ethers, benzyls, and benzyl ketals may be used.

As an example, the photoinitiator may be benzoin ethers (e.g., benzoin methyl ether or benzoin isopropyl ether) or substituted benzoin ethers.

As another example, the photoinitiator may be substituted acetophenone, for example, 2,2-diethoxyacetophenone or 2,2-dimethoxy-2-phenylacetophenone.

As yet another example, the photoinitiator may be substituted alpha-ketones (e.g., 2-methyl-2-hydroxypropiophenone), aromatic sulfonyl chlorides (e.g., 2-naphthalenesulfonyl chloride), or photoactive oximes (e.g., 1-phenyl-1,2-propanedione-2-(O-ethoxycarbonyl)oxime).

As still another example, the photoinitiator may be 1-hydroxycyclohexyl phenyl ketone, bis(2,4,6-trimethylbenzoyl) phenylphosphine oxide, 1-[4-(2-hydroxyethoxy)phenyl]-2-hydroxy-2-methyl-1-propane-1-one, 2-benzyl-2-dimethylamino-1-(4-morpholinophenyl)butanone, 2-methyl-1-[4-(methylthio)phenyl]-2-morpholinopropane-1-one, 2-hydroxy-2-methyl-1-phenylpropane-1-one, and the like.

Examples of commercially available photoinitiators may include Ciba IRGACURE series from Ciba Specialty Chemicals Co., Ltd., Esacure KIP series from IGM Resins Co., Ltd., and the like.

As the thermal initiator, according to a polymerization method to be used, a water-soluble or water-insoluble (i.e., oil-soluble) thermal initiator may be selectively used.

As the water-soluble initiator, persulfates such as potassium persulfate, ammonium persulfate, sodium persulfate, and mixtures thereof; oxidation-reduction initiators such as a reaction product of a reducing agent such as metabisulfite (e.g., sodium metabisulfite) or bisulfate (e.g., sodium bisulfate) and persulfate; or 4,4′-azobis(4-cyanopentanoic acid) and its soluble salts (e.g., sodium salt, potassium salt), or the like may be used.

As the oil-soluble initiator, azos such as 2,2′-azobis(2-methylbutanenitrile), 2,2′-azobis(isobutyronitrile), and 2,2′-azobis(2,4-dimethylpentanenitrile); or peroxides such as benzoyl peroxide, cyclohexane peroxide, and lauroyl peroxide may be used.

The viscosity of the prepolymer may be 1,000 to 5,000 cP, preferably 1,500 to 4,500 cP, more preferably 2,000 to 4,000 cP. When the viscosity of the prepolymer satisfies the above range, the adhesive property and the physical properties of the adhesive layer may be further improved.

A weight average molecular weight (Mw) of the prepolymer may be 10,000 to 2,000,000. Alternatively, the weight average molecular weight of the prepolymer may be 100,000 to 2,000,000. When the weight average molecular weight of the prepolymer satisfies the above range, the adhesive property and the physical properties of the adhesive layer may be further improved.

Meanwhile, according to the exemplary embodiment of the present invention, the photocurable adhesive composition includes a second initiator. For example, the photocurable adhesive composition may include the second initiator, specifically the photoinitiator to cure the photocurable adhesive composition.

Further, the second initiator included in the photocurable adhesive composition may comprise a type of first initiator used in the prepolymerization composition forming the prepolymer. The content of the second initiator may be 0.05 parts by weight to 0.3 parts by weight based on 100 parts by weight of the prepolymer. The content of the second initiator may be 0.05 to 0.25 parts by weight, 0.07 to 0.2 parts by weight, 0.07 to 0.18 parts by weight, or 0.07 to 0.14 parts by weight, based on 100 parts by weight of the prepolymer. When the content of the second initiator is less than the above range, the content of the remaining monomer after a photocurable reaction is high, and thus, the peeling adhesion may be lowered, and when the content of the second initiator is equal to or more than the above range, the molecular weight of a polymer generated after the photocurable reaction is small, and thus, there is a problem that the creep resistance is low. When the content of the second initiator satisfies the above range, it may be further advantageous to form a photocurable adhesive with a high molecular weight.

Further, according to the exemplary embodiment of the present invention, the photocurable adhesive composition includes a crosslinking agent.

The crosslinking agent may react with the prepolymer to form a film and the like.

The content of the crosslinking agent in the composition may be 0.01 to 0.5 parts by weight based on 100 parts by weight of the prepolymer. Specifically, the content of the crosslinking agent in the composition may be 0.05 to 0.25 parts by weight, preferably 0.07 to 0.2 parts by weight, more preferably 0.08 to 0.2 parts by weight or 0.08 to 0.15 parts by weight based on 100 parts by weight of the prepolymer.

The crosslinking agent may contain functional groups which are reactive with the functional groups of the prepolymer.

For example, the crosslinking agent may have one or at least two functional groups selected from the group consisting of an epoxy group, an isocyanate group, a carboxyl group, a hydroxyl group, an acryl group, a methacryl group, an acetate group, and a vinyl group.

As a specific example, the crosslinking agent may have an epoxy group or an isocyanate group.

The crosslinking agent may be a photo-crosslinking agent, a thermal crosslinking agent, or a combination thereof.

As the photo-crosslinking agent, a general multifunctional acrylic compound can be used.

For example, the photo-crosslinking agent may be at least one selected from the group consisting of diacrylate and triacrylate. Specific examples of the photo-crosslinking agent may include 1,4-butanediol diacrylate, 1,6-hexanediol diacrylate (HDDA), 1,9-nonanediol diacrylate, tripropylene glycol diacrylate, tetraethylene glycol diacrylate, trimethylolpropane triacrylate, and pentaerythritol triacrylate.

The thermal crosslinking agent may be an isocyanate-based, epoxy-based, or metal chelate-based compound.

The isocyanate-based compound may be a multifunctional aromatic or aliphatic isocyanate compound. For example, the isocyanate-based compound may be trimerized isocyanate such as a toluene diisocyanate-trimethylol propane (TDI-TMP) adduct.

The epoxy-based compound may have one or at least two epoxy groups, and may have a functional group reactive with the prepolymer.

The metal chelate-based compound may be a chelate-based compound having a metal such as Zn, Ni, Mn, Fe, Co, Cr, Al, Ti or Zr.

Examples of the commercially available thermal crosslinking agent may include Saivinol hardener series from Saiden Chemical Industry Co., Ltd.

The photocurable adhesive composition according to the exemplary embodiment may further include other additives if necessary.

Specific examples of the additives include tackifiers (e.g., rosin ester, terpene, phenol, and aliphatic synthetic hydrocarbon resin, aromatic synthetic hydrocarbon resin, or a mixture of aliphatic synthetic hydrocarbon resin and aromatic synthetic hydrocarbon resin), surfactants, plasticizers (other than a physical foaming agent), nucleating agents (e.g., talc, silica, or TiO₂), fillers (e.g., inorganic fillers and organic fillers), fiber, aging inhibitors, antioxidants, UV-absorbers, antistatic agents, lubricants, pigments, dyes, reinforcing agents, hydrophobic or hydrophilic silica, calcium carbonate, toughening agents, flame retardants, finely grinded polymeric particles (e.g., polyester, nylon, or polypropylene), stabilizers (e.g., UV stabilizer), and combinations thereof.

The content of the additives is not particularly limited as an appropriate amount to obtain desired properties of the composition, but may be, for example, 0.1 to 10 parts by weight or 0.1 to 5 parts by weight based on 100 parts by weight of the prepolymer.

The photocurable adhesive composition according to the exemplary embodiment may be configured so that various components illustrated above have specific contents.

According to an exemple, the photocurable adhesive composition may include 100 parts by weight of the prepolymer, 0.5 to 10 parts by weight of the acrylic monomer, 0.01 to 0.5 parts by weight of the crosslinking agent, and 0.05 to 0.3 parts by weight of the second initiator.

According to another exemple, the photocurable adhesive composition may include 100 parts by weight of the prepolymer, 1 to 8 parts by weight of the acrylic monomer, 0.05 to 0.25 parts by weight of the crosslinking agent, and 0.05 to 0.25 parts by weight of the second initiator.

According to yet another exemple, the photocurable adhesive composition may include 100 parts by weight of the prepolymer, 3 to 8 parts by weight of the acrylic monomer, 0.07 to 0.2 parts by weight of the crosslinking agent, and 0.07 to 0.2 parts by weight of the second initiator.

The photocurable adhesive composition may include 100 parts by weight of the prepolymer, 3 to 6.5 parts by weight of the acrylic monomer, 0.08 to 0.2 parts by weight of the crosslinking agent, and 0.07 to 0.18 parts by weight of the second initiator.

At this time, the contents of the components in the adhesive composition may be based on the solid content.

Meanwhile, referring to FIG. 3, a preparation method (S200) of the photocurable adhesive composition according to the exemplary embodiment of the present invention may include preparing a prepolymerization composition by mixing a first monomer, a second monomer, and a first initiator (S210); preparing a prepolymer by prepolymerizing the prepolymerization composition (S220); and mixing the prepolymer, an acrylic monomer, a second initiator, and a crosslinking agent (S230).

Further, the photocurable adhesive composition may be prepared by further mixing other additives if necessary.

In addition, the viscosity may be adjusted by using a solvent in each mixing step.

The content of each component is as described above.

However, the preparation method of the adhesive composition is not particularly limited, and the process conditions may be appropriately modified if necessary.

### Release Layer

The photocurable adhesive film according to the exemplary embodiment of the present invention includes at least one release layer.

The release layer is coated with a liquid component and serves as a carrier of helping a process of passing through a drying furnace and a support for supporitng the adhesive layer before using. Further, the release layer serves to protect an adhesive surface until a final using time after the coating liquid of the adhesive compostion is dried.

The at least one release layer may include a plurality of release layers.

The plurality of release layers may include a first release layer and a second release layer.

The first release layer and the second release layer may incude at least one selected from the group consisting of, for example, a polyester (PET) film, a polyethylene (PE) film, a polypropylene (PP) film, and paper.

Further, the first release layer may include a fluorine-based release layer. Specifically, the first release layer may comprise fluorine-containing PET. More specifically, the first release layer may comprise PET treated with a fluorine-based release agent. The fluorine-based release layer may have excellent releasability by imparting lubricity using excellent non-adhesion of the fluorine compound.

The second release layer may comprise a silicon-based release layer. Specifically, the second release layer may comprise silicon-containing PET. More specifically, the second release layer may comprise PET treated with a silicon-based release agent. The silicon-based release agent may be used as a polysiloxane polymer having a reactive group for a group containing an Si—H bond in a molecule. The reactive group to the group containing the Si—H bond may include at least one selected from the group consisting of an alkenyl group, such as a vinyl group and a hexenyl group. The silicon-based release layer has excellent lubrication and good releasability.

The first release layer and the second release layer include silicon-based or fluorine-based release layers, respectively, so that the adhesive layer is not damaged and natural peeling may occur.

### Structure of Photocurable Adhesive Film

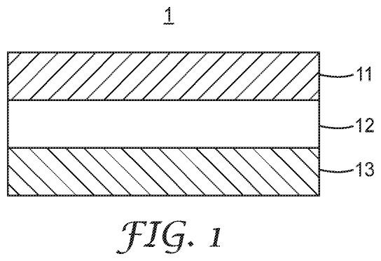

Referring to FIG. 1, a photocurable adhesive film 1 includes an adhesive layer 12 and release layers 11 and 13, and specifically, the adhesive layer 12 may be disposed between the first release layer 11 and the second release layer 13. At this time, the adhesive layer 12 and the first release layer 11 may be bonded to each other. Further, the adhesive layer 12 and the second release layer 13 may be bonded to each other. Further, the adhesive layer 12 may be bonded to both the first release layer 11 and the second release layer 13.

The photocurable adhesive film according to the exemplary embodiment of the present invention may have a thickness in a range of 5 μm to 1000 μm or 10 μm to 100 μm when prepared as a thin film.

Alternatively, the thickness of the adhesive film may be in a range of 0.1 mm to 5 mm or 1 mm to 3 mm when prepared as a thick film.

The adhesive layer may have a thickness in a range of 5 μm to 1000 μm or 10 μm to 100 μm.

The first release layer and the second release layer may have a thickness in a range of 5 μm to 100 μm or 10 μm to 100 μm.

When the thicknesses of the first release layer and the second release layer are too thin, there is a disadvantage that it is difficult to support and preserve the adhesive layer, and when the thicknesses are too thick, there may be a problem that winding may be interrupted and the shape of the used adhesive film may be modified.

However, the thicknesses of the first release layer and the second release layer may be thinner or thicker if necessary unless the effect of the present invention is inhibited.

### Physical Properties of Photocurable Adhesive Film

The photocurable adhesive film according to the exemplary embodiment of the present invention has 180° peeling adhesion of 550 to 800 gf/inch at 70° C. Specfically, the photocurable adhesive film has 180° peeling adhesion of 570 to 800 gf/inch at 70° C. More specfically, the photocurable adhesive film has 180° peeling adhesion of 570 to 790 gf/inch or 575 to 660 gf/inch at 70° C.

In the photocurable adhesive film according to the exemplary embodiment of the present invention, the adhesive layer has 180° peeling adhesion of 900 to 1300 gf/inch at room temperature. Specfically, the adhesive layer has 180° peeling adhesion of 900 to 1200 gf/inch at room temperature. More specfically, the adhesive layer has 180° peeling adhesion of 900 to 1150 gf/inch or 930 to 1150 gf/inch at room temperature. The 180° peeling adhesion may be measured by cutting the photocurable adhesive film with a width of 1 inch, removing a release film, attaching the photocurable adhesive film to a stainless steel (SUS) substrate at room temperature for 1 hour, and then peeling the photocurable adhesive film at an angle of 180° at a peeling rate of 305 mm/min at room temperature or 70° C.

The photocurable adhesive film according to the exemplary embodiment of the present invention may have a creep strain of 38% or less at 60° C. after photocuring. Specifically, the photocurable adhesive film may have a creep strain of 35% or less, 30% or less, 28% or less, 26% or less, 25% or less, or 24% or less at 60° C. after photocuring. More specifically, the photocurable adhesive film may have a creep strain of 20% to 38%, 20% to 35%, 20% to 30%, 20% to 38%, or 20% to 25% at 60° C. after photocuring.

The creep strain means that the deformation of a material continues according to the elapse of time in a state where a constant load is applied. Therefore, it is meant that the lower the creep strain, the better the creep resistance. That is, when the creep strain is low, it is possible to reduce occurrence of defects such as deformation or cracks and delamination.

In the creep strain, a creep strain test may be perforemd under measument conditions of a static stress of 2000 Pa, a creep time of 600 seconds, and a restoring time of 600 seconds at 60° C. using a DHR-2 rheometer TA instrument after folding the 25 μm-thick adhesive layer 32 times to make a thickness of 800 μm.

Meanwhile, the photocurable adhesive film according to the exemplary embodiment of the present invention may have a shear modulus of 0.35 to 0.50 Mpa at −20° C. after photocuring. Specifically, the photocurable adhesive film may have a shear modulus of 0.35 to 0.49 Mpa, 0.35 to 0.46 Mpa, 0.35 to 0.45 Mpa, 0.35 to 0.43 Mpa, 0.35 to 0.42 Mpa, or 0.35 to 0.40 Mpa at −20° C. after photocuring.

The shear modulus is evaluated as a modulus value at −20° C. measured under conditions of a strain of 0.02 to 15%, an axial force of 1 N, and a vibration frequency of 10 rad/sec after raising a temperature of −50° C. to 150° C. at a rate of 5 ° C./min using an ARES-G2 rheometer TA instrument.

In the photocurable adhesive film according to the exemplary embodiment of the present invention, the adhesive layer may have a tangent delta at a temperature of 150° C. of 0.2 to 0.4, 0.22 to 0.38, 0.2 to 0.35, or 0.25 to 0.35. The tangent delta means a ratio of a shear loss modulus to a shear storage modulus and a small tangent delta value means that the shear storage modulus is large and elasticity is strong.

The adhesive film may satisfy requirements as an optically transparent adhesive film before UV curing. For example, the adhesive film may have a haze before UV curing of 5% or less, 2% or less, or 1% or less. In addition, the adhesive film may have a light transmittance before UV curing of 80% or more, 90% or more, or 95% or more.

The adhesive film may satisfy requirements as the optically transparent adhesive film even after UV curing. For example, the adhesive film may have a haze after UV curing of 5% or less, 2% or less, or 1% or less. In addition, the adhesive film may have a light transmittance after UV curing of 80% or more, 90% or more, or 95% or more.

The photocurable adhesive film according to the exemplary embodiment of the present invention has physical properties suitable to be used for display devices, particularly, a foldable display.

### Preparation Method of Photocurable Adhesive Film

A preparation method of a photocurable adhesive film according to an examplary embodiment of the present invention comprises preparing at least one release layer; and forming an adhesive layer by coating a photocurable adhesive composition on the at least one release layer, wherein the photocurable adhesive composition includes a prepolymer; an acrylic monomer having the structural formula; an initiator; and a crosslinking agent and includes the acrylic monomer in an amount of 0.5 to 10 parts by weight based on 100 parts by weight of the prepolymer.

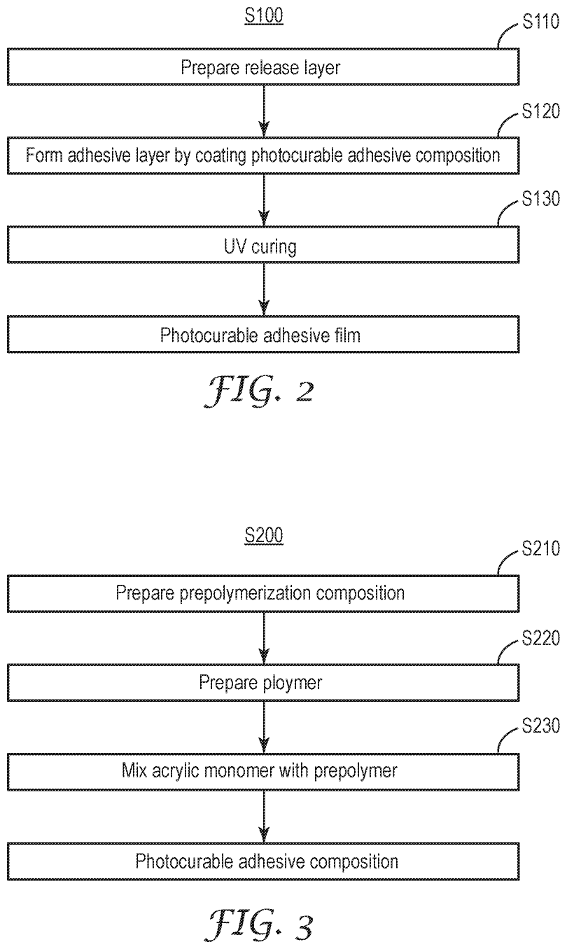

Referring to FIG. 2, the preparation method (S100) of the photocurable adhesive film may include preparing at least one release layer (S110).

The at least one release layer includes a first release layer and a second release layer and the types and the thicknesses of the first release layer and the second release layer are as described above.

The preparation method of the photocurable adhesive film may include forming the adhesive layer by coating the photocurable adhesive composition on the at least one release layer (S120). Alternatively, the photocurable adhesive film may include forming the adhesive layer by coating the photocurable adhesive composition between the two release layers, that is, the first release layer and the second release layer.

The preparation method of the photocurable adhesive composition may be performed according to the conditions and processes described above.

Specifically, the photocurable adhesive film according to the exemplary embodiment of the present invention may be prepared by a method of coating and photocuring the photocurable adhesive composition between the first release layer and the second release layer to form the adhesive layer.

Alternatively, a photocurable adhesive film according to another exemplary embodiment of the present invention may be prepared by coating and photocuring the photocurable adhesive composition on one surface of the first release layer or the second release layer to form an adhesive layer and then bonding the other release layer on one surface of the adhesive layer.

The photocuring process may be performed by coating the adhesive composition on at least one release layer. Specfically, the photocurable adhesive composition may be coated on at least one release layer with an appropriate thickness and the coating may be performed by a method such as notch bar, comma, gravure, or die coating. In addition, the coating rate may be in a range of about 1 m/min to 40 m/min or 5 m/min to 30 m/min.

The preparation method of the photocurable adhesive film may further include photocuring (S130).

The photocuring condition may include a two-stage photocuring.

Specifically, the photocuring condition may include first photocuring of a UV intensity of 2.1 w/cm² and a residence time of 50 to 100 seconds; and second photocuring of a UV intensity of 9.0 w/cm² and a residence time of 100 to 150 seconds.

The physical properties of the photocurable adhesive film according to the exemplary embodiment of the present invention, specificlally the physical properties of the adhesive layer may be physical properties evaluated after performing the two-stage photocuring conditions.

The photocurable adhesive film according to the exemplary embodiment of the present invention may be used for display devices, and particularly, may be usefully used as an adhesive film in a display panel manufacturing process in a foldable display device field.

The display panel may be, for example, an organic light emitting diode (OLED) display panel or a liquid crystal display (LCD) panel.

### EXAMPLES

Hereinafter, the present invention will be described in more detail through Examples. However, these Examples are just to exemplify the present invention and the present invention is not limited thereto.

### Example 1

### Preparation of Photocurable Adhesive Composition

2-ethylhexyl acrylate (2-EHA) as a first monomer and acrylic acid (AA) as a second monomer were mixed at a weight ratio of 95.5:4.5 to prepare 100 parts by weight of a monomrer mixture. The monomer mixture was added with 0.04 parts by weight of IRG651 as a first initiator and sufficiently mixed for about 5 minutes to obtain a prepolymerization composition (S210).

The prepolymerization composition was prepolymerized using a DTP UV curing machine (del T=7° C.) to obtain a prepolymer with a viscosity of about 2,000 cP (S220).

Next, IRG651 as a second initiator, 1,6-hexanediol diacrylate (HDDA) as a crosslinking agent, and β-carboxyethyl acrylate (β-CEA) as an acrylic monomer were added to the prepolymer in contents shown in Table 1, respectively, and mixed for about 8 to 12 hours using a roll mixer (S230) to obtain a photocurable adhesive composition with a tranparent viscosity (S200).

### Preparation of Photocurable Adhesive Film

The photocurable adhesive composition was coated on the release layers under the following conditions using a KCD1 pilot coater to form an adhesive layer and prepare a photocurable adhesive film.

### Structure of Photocurable Adhesive Film

Thickness of adhesive layer: 25 μm
First release layer (upper): Fluorine-based PET (9250ORZASD, Kern Chemical)
Second release layer (lower): Silicon-based PET (RF12ASW75, SK Hightech)

### Curing Condition

Step 1: UV intensity of 2.1 W/cm 2 , Residence time=50 seconds
Step 2: UV intensity of 9.0 W/cm 2 , Residence time=150 seconds
Max line speed: 2.1 mpm

### Examples 2 and 3

Except for changing a used amount of β-CEA to contents shown in Table 1 below, a photocurable adhesive composition and a photocurable adhesive film were obtained in the same manner as Example 1.

### Examples 4 to 6

Except for using a prepolymerization compostion of changing used amounts of 2-EHA and AA to contents shown in Table 1 below and changing IRG65 1 (DAEHAN Chemicals) and β-CEA to amounts of 0.1 parts by weight and 5 parts by weight based on 100 parts by weight of the prepolymer, respectively, a photocurable adhesive composition and a photocurable adhesive film were obtained in the same manner as Example 1.

### Example 7

Except for changing a used amount of β-CEA to contents shown in Table 1 below, a photocurable adhesive composition and a photocurable adhesive film were obtained in the same manner as Example 6.

### Comparative Example 1

2-ethylhexyl acrylate (2-EHA, LG Chemicals) as a first monomer and acrylic acid (AA, LG Chemicals) as a second monomer were mixed at a weight ratio of 95.5:4.5 to prepare 100 parts by weight of a monomrer mixture. 0.15 parts by weight of IRG651 (DAEHAN Chemicals) as an initiator and 0.15 parts by weight of HDDA as a crosslinking agent based on 100 parts by weight of the monomer mixture were added to the monomer mixture and mixed for about 8 to 12 hours using a roll mixer to obtain a photocurable adhesive composition and a photocurable adhesive film.

### Comparative Example 2

Except for changing a used amount of HDDA as a crosslinking agent to 0.12 parts by weight, a photocurable adhesive composition and a photocurable adhesive film were obtained in the same manner as Comparative Example 1.

The components and contents of respective materials were shown in Table 1 below:

TABLE 1

| | | | | | | | | | Comparative | |
|---|---|---|---|---|---|---|---|---|---|---|
| Classfication (parts by | | Examples | | | | | | | Examples | |
| weight) | | 1 | 2 | 3 | 4 | 5 | 6 | 7 | 1 | 2 |
| Prepolymerization | 2-EHA | 95.5 | 95.5 | 95.5 | 96 | 96.5 | 97 | 97 | 95.5 | 95.5 |
| composition | AA | 4.5 | 4.5 | 4.5 | 4 | 3.5 | 3 | 3 | 4.5 | 4.5 |
| | IRG651 | 0.04 | 0.04 | 0.04 | 0.04 | 0.04 | 0.04 | 0.04 | | |
| Photocurable | β-CEA | 1 | 3 | 5 | 5 | 5 | 5 | 6.5 | 0 | 0 |
| adhesive | IRG651 | 0.15 | 0.15 | 0.15 | 0.1 | 0.1 | 0.1 | 0.1 | 0.15 | 0.15 |
| composition | HDDA | 0.12 | 0.12 | 0.12 | 0.12 | 0.12 | 0.12 | 0.12 | 0.15 | 0.12 |

In the photocurable adhesive composition, the used amounts of β-CEA, IRG651 and HDDA are based on 100 parts by weight of the prepolymer.

2-EHA: 2-ethylhexyl acrylate (LG Chemicals)
AA: Acrylic acid (LG Chemicals)
β-CEA: β-carboxyethyl acrylate (DSW Chemicals)
IRG651 (DEAHAN Chemicals)
HDDA: 1,6-hexanidiol diacrylate (SK Cytec)

### TEST EXAMPLES

### Test Example 1: Shear Storage Modulus (G′)

The 25 μm-thick adhesive layer was folded 32 times to make a thickness of 800 μm and then a shear storage modulus was measured by using an ARES-G2 rheometer TA instrument. The measurent condition of the shear storage modulus was as follows and modulus values at −20° C. were measured and shown in Table 2.
Temperature change: −50° C. to 150° C.
Temperature rising rate: 5 ° C./min
Strain: 0.02 to 15%
Axial force: 1 N
Vibration frequency: 10 rad/sec

### Test Example 2: Shear Loss Modulus (G″)

The 25 μm-thick adhesive layer was folded 32 times to make a thickness of 800 μm and then a shear loss modulus was measured by using an ARES-G2 rheometer TA instrument. The measurent condition of the shear loss modulus was the same as the measurent condition of the shear storage modulus to obtain data.

### Test Example 3: Tangent Delta (Tan Del)

The 25 μm-thick adhesive layer was folded 32 times to make a thickness of 800 μm and then a tangent delta value was measured by using an ARES-G2 rheometer TA instrument. The measurent condition of the tangent delta was the same as the measurent condition of the shear storage modulus to obtain data.

The tangent delta refers to a ratio of the shear loss modulus to the shear storage modulus.

### Test Example 4: Creep Strain (%)

The 25 μm-thick adhesive layer was folded 32 times to make a thickness of 800 μm and then a creep strain test was performed by using a DHR-2 rheometer TA instrument. The measurement condition of the creep strain was as follows.
Test temperature: 60° C.
Static stress: 2000 Pa
Creep time: 600 seconds
Restoring time: 600 seconds

### Test Example 5: 180° Peeling Adhesion

The measurement condition of the 180° peeling adhesion was as follows.
Test substrate: SUS
Flexible strip: 25 μm PET (1 inch width)
Aging: 1 hour at room temperature
Test temperature: Room temperature, 70° C.
Peeling rate: 305 mm/min
Each sample was repeated 3 times.

The evaluation results of Test Examples were shown in Table 2 below.

TABLE 2

| | | | | | | | | Comparative | |
|---|---|---|---|---|---|---|---|---|---|
| | Examples | | | | | | | Examples | |
| Classification | 1 | 2 | 3 | 4 | 5 | 6 | 7 | 1 | 2 |
| G' (−20° C.) (MPa) | 0.38 | 0.46 | 0.49 | 0.43 | 0.42 | 0.35 | 0.38 | 0.32 | 0.38 |
| Tan del (150° C.) | 0.32 | 0.3 | 0.29 | 0.26 | 0.26 | 0.28 | 0.26 | 0.21 | 0.34 |
| Creep strain (%), 60° C. | 37.09 | 29.75 | 29.8 | 22.6 | 23.55 | 24.82 | 22.85 | 23.09 | 39.87 |
| 180° peeling | 940 | 1005 | 1150 | 1010 | 1085 | 935 | 1030 | 750 | 785 |
| adhesion, room | | | | | | | | | |
| temperature | | | | | | | | | |
| (gf/inch) | | | | | | | | | |
| 180° peeling | 630 | 675 | 790 | 625 | 625 | 575 | 660 | 480 | 530 |
| adhesion, | | | | | | | | | |
| 70° C. (gf/inch) | | | | | | | | | |

As can be seen in Table 2, the photocurable adhesive films prepared in Examples 1 to 7 showed significantly excellent effects of physical properties compared to the photocurable adhesive films prepared in Comparative Examples 1 and 2.

Specifically, first, when comparing Examples 1 to 3 and Comparative Example 2 using the mononmer mixture, the second initiator, and the curing agent in the same contents, it can be seen that the photocurable adhesive films of Examples 1 to 3 using β-CEA were increased in 180° peeling adhesion at room temperature and 70° C. and decreased in creep strain as compared with the photocurable adhesive film of Comparative Example 2.

Particularly, it can be seen that in Examples 1 to 3, as the content of β-CEA was increased, the 180° peeling adhesion was increased, and the photocurable adhesive film of Example 3 using 5 parts by weight of β-CEA was increased in 180° peeling adhesion at 70° C. to 790 gf/inch and significantly increased as compared with the photocurable adhesive film of Comparative Example 2 having the 180° peeling adhesion of 530 gf/inch.

Meanwhile, in the case of the shear storage modulus (G′), even though the content of β-CEA was increased up to 5 times, G′ at a low temperature of −20° C. was not greately increased.

Above all, the photocurable adhesive films of Examples 1 to 3 were decreased in creep strain as compared with the photocurable adhesive films of Comparative Examples 1 and 2, and the photocurable adhesive film of Example 3 using 5 parts by weight of β-CEA was significantly decreased in creep strain as 29.8% as compared with the photocurable adhesive film of Comparative Example 2 as 39.87%.

Meanwhile, in the case of the photocurable adhesive films of Examples 3 to 6 using 5 parts by weight of the content of β-CEA, decreasing the centent of the second initator to 0.1 parts by weight, and gradually decreasing the centent of the acrylic acid to 4.5 parts by weight, 4 parts by weight, 3.5 parts by weight, and 3 parts by weight, it can be seen that the creep strain was significantly decreased up to 22.6 to 29.8% and G′ at the low temperature of −20° C. was decreased up to 0.35 Mpa as compared with the photocurable adhesive films of Examples 1 and 2 and Comparative Examples 1 and 2.

Further, in the case of the photocurable adhesive film of Example 7 using the content of β-CEA in an amount of 6.5 parts by weight, it was confirmed that the creep strain was significantly lowered to 22.85% and the 180° peeling adhesions at room temperature and 70° C. were 1030 gf/inch and 660 gf/inch, respectively, and significantly improved as compared with the photocurable adhesive films of Comparative Examples 1 and 2.

Therefore, according to the exemplary embodiment of the present invention, it was confirmed that β-CEA was used and the contents of monomers were adjusted, so that it is possible to provide an adhesive film with excellent physical properties, such as decreases in the peeling adhesions at room temperature and high temperature of 70° C., the creep resistance at a high temperature of 60° C., and the shear storage modulus at a low temperature of −20° C., and the like.

### EXPLANATION OF REFERENCE NUMERALS AND SYMBOLS

1: Photocurable adhesive film
11: First release layer
12: Adhesive layer
13: Second release layer

1. A photocurable adhesive film comprising:
an adhesive layer and at least one release layer,
wherein the adhesive layer is induced from a photocurable adhesive composition comprising a prepolymer; an acrylic monomer having the following structural formula; an initiator; and a crosslinking agent, and
the photocurable adhesive composition comprises the acrylic monomer in an amount of 0.5 to 10 parts by weight based on 100 parts by weight of the prepolymer: 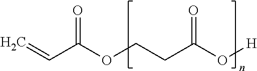
wherein, n is an integer of 1 to 3.

2. The photocurable adhesive film of claim 1, wherein the acrylic monomer has a glass transition temperature (Tg) of 10° C. to 50° C.

3. The photocurable adhesive film of claim 2, wherein the acrylic monomer comprises β-carboxyethyl acrylate (β-CEA).

4. The photocurable adhesive film of claim 1, wherein the adhesive layer has 180° peeling adhesion of 550 to 800 gf/inch at 70° C. and 180° peeling adhesion of 900 to 1300 gf/inch at room temperature with respect to the adhesive layer after photocuring.

5. The photocurable adhesive film of claim 1, wherein the photocurable adhesive film has a creep strain of 38% or less at 60° C. after photocuring and has a shear modulus of 0.35 to 0.50 Mpa at −20° C. after photocuring.

6. The photocurable adhesive film of claim 1, wherein the prepolymer is formed from a prepolymerization composition comprising a first monomer and a second monomer, and has a viscosity of 1,000 to 5,000 cP.

7. The photocurable adhesive film of claim 6, wherein the first monomer comprises an aliphatic or aromatic hydrocarbon-based acrylate monomer having 1 to 30 carbon atoms, and
the second monomer comprises a functional monomer containing at least one hetero atom.

8. The photocurable adhesive film of claim 6, wherein a weight ratio of the first monomer and the second monomer is 1:0.01 to 0.1.

9. The photocurable adhesive film of claim 1, wherein the contents of the initiator and the crosslinking agent are 0.05 to 0.3 parts by weight and 0.01 to 0.5 parts by weight based on 100 parts by weight of the prepolymer, respectively.

10. The photocurable adhesive film of claim 1, wherein the at least one release layer includes a plurality of release layers,
the plurality of release layers includes a first release layer and a second release layer,
the adhesive layer is disposed between the first release layer and the second release layer,
the first release layer is a fluorine-based release layer, and
the second release layer is a silicon-based release layer.

11. A preparation method of a photocurable adhesive film comprising:
preparing at least one release layer; and
forming an adhesive layer by coating a photocurable adhesive composition on the at least one release layer,
wherein the photocurable adhesive composition comprises a prepolymer; an acrylic monomer having the following structural formula; an initiator; and a crosslinking agent, and comprises the acrylic monomer in an amount of 0.5 to 10 parts by weight based on 100 parts by weight of the prepolymer: 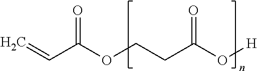
wherein, n is an integer of 1 to 3.

12. The preparation method of claim 11, wherein the acrylic monomer comprises β-carboxyethyl acrylate (β-CEA).

13. The preparation method of claim 11, wherein the prepolymer is formed from a prepolymerization composition comprising a first monomer and a second monomer, and has a viscosity of 1,000 to 5,000 cP.

14. The preparation method of claim 13, wherein the first monomer comprises an aliphatic or aromatic hydrocarbon-based acrylate monomer having 1 to 30 carbon atoms, and
the second monomer comprises a functional monomer containing at least one hetero atom.

15. The preparation method of claim 13, wherein a weight ratio of the first monomer and the second monomer is 1:0.01 to 0.1.

16. The preparation method of claim 11, wherein the contents of the initiator and the crosslinking agent are 0.05 to 0.3 parts by weight and 0.01 to 0.5 parts by weight based on 100 parts by weight of the prepolymer, respectively.

17. The photocurable adhesive film of claim 3, wherein the prepolymer is formed from a prepolymerization composition comprising a first monomer and a second monomer, and has a viscosity of 1,000 to 5,000 cP.

18. The photocurable adhesive film of claim 17, wherein the first monomer comprises an aliphatic or aromatic hydrocarbon-based acrylate monomer having 1 to 30 carbon atoms, and
the second monomer comprises a functional monomer containing at least one hetero atom.

19. The photocurable adhesive film of claim 17, wherein a weight ratio of the first monomer and the second monomer is 1:0.01 to 0.1.

20. The photocurable adhesive film of claim 3, wherein the contents of the initiator and the crosslinking agent are 0.05 to 0.3 parts by weight and 0.01 to 0.5 parts by weight based on 100 parts by weight of the prepolymer, respectively.
